(19) United States
(12) Patent Application Publication
(10) Pub. No.: US 2004/0002916 A1
(43) Pub. Date: Jan. 1, 2004

(54) Systems and methods for managing balance transfer accounts

(76) Inventors: Sarah Timmerman, Richmond, VA (US); Aaron Fidler, Washington, DC (US); Kenneth Moore, Richmond, VA (US)

Correspondence Address: Finnegan, Henderson, Farabow,, Garrett & Dunner, L.L.P., 1300 I Street, N.W., Washington, DC, 20005-3315, US

(21) Appl. No.: 10/186,137

(22) Filed: Jul. 1, 2002

(51) Int. Cl. G06F 17/60

(52) U.S. Cl. 705/39

(57) ABSTRACT

Systems and methods consistent with the present invention manage balance transfer accounts associated with customer pre-existing debt accounts. The system first creates a balance transfer account for the customer, which may include opening the balance transfer account to allow the customer to activate it. The method then determines whether a payment to the balance transfer account received from the customer meets a payment threshold criteria. If the received payment meets the payment threshold criteria, then a credit bureau is notified of the balance transfer account and the balance transfer account remains open. If the received payment does not meet the payment threshold criteria, then the balance transfer account is closed without notification to the credit bureau.

### BACKGROUND OF THE INVENTION

1. Field of the Invention

The present invention generally relates to debt recovery and, more particularly, to improved systems and methods for managing balance transfer accounts.

2. Description of the Related Art

Credit issuing businesses of all sizes and types sometimes have problems with customers who are delinquent in paying off debt. Non-payment of debt, such as credit card debt, may cost businesses millions of dollars in revenue each year. Most credit issuers do not wait indefinitely for delinquent customers to pay their debt. Instead, to recover all or a portion of the debt, they usually employ various tactics to collect payments from their delinquent customers.

Many credit issuers initially make an effort to collect overdue payments using some type of reminder, such as a letter or a telephone call. Initial efforts are usually non-confrontational in case there has been a misunderstanding, such as when the customer erroneously believes the debt had been previously paid or when the credit issuer has not yet received the payment already sent by the customer. For such customers, a credit issuer will likely receive any late payment from a customer in response to a reminder. For other customers, however, the reminder will not be sufficient and their debts will remain unpaid.

An account that remains overdue for a lengthy period may be designated as a charged-off account. A charged-off account is an account on which a customer has not made a payment for a predetermined time period. Credit issuers consider charged-off accounts “written off” from their books (e.g., no longer receivable). As such, charged-off accounts represent a negative industry metric since they are essentially unrecoverable assets. While credit issuers may continue to attempt collection on a charged-off account, the account itself is usually deactivated long before, such that the customer may no longer use the account to create further debt.

If initial collection efforts fail, some credit issuers resort to using debt collection agencies to collect payments from delinquent customers. For example, a, credit issuer may give a number of charged-off or delinquent accounts to an agency, while retaining ownership of the accounts. When customers provide payments to the agency, the agency keeps a percentage (e.g., 50%) and forwards the remainder to the credit issuer. Credit issuers may also try selling a portfolio of charged-off accounts to an agency. Under this arrangement, agencies essentially buy portfolios of delinquent debt for a fraction of the total debt amount (e.g., pennies or less on the dollar) and attempt collection. Accordingly, a customer then owes the debt-collecting agency instead of the original credit issuing business.

The practice of buying portfolios of charged-off debt comes with a risk, however, as there is a good chance that the customer will not pay. Because of this risk, the original debt-holder often has to accept much less than the amount of the charged-off debt, because the buyer of the debt is taking a non-performing asset. Neither the debt-holder nor the buyer of the debt knows which customers will make payments on the charged-off debt or the amount of those payments.

One possible reason for a customer's non-willingness to pay is that repayment plans are often unattractive to the customer. For example, the debt-holder may not offer any incentive for making repayments, other than repairing the customer's credit history or preventing further phone calls or other collection attempts. This is often insufficient to prod customers into repayment. Other repayment plans may offer the customer an adequate incentive, such as a new line of credit, but may require a substantial portion of repayment before the incentive becomes available. For example, a debt-holder may offer customers a new line of credit only upon full repayment of the debt. Satisfaction of this requirement may seem so unlikely or so distant to the customer that the incentive is not realistic. Moreover, other payment or settlement plans may be unattractive to the credit issuer, such as when the issuer offers too large an incentive to the customer. In those cases, the issuer risks losing money, even though the customer may make a substantial payment. Regardless of whether the credit issuer or a purchasing agency is the current debt-holder, their goal is to obtain payment from the customer.

One method debt-holders have used to entice customers to follow a repayment plan is to issue a reaffirmation credit card. As part of receiving such a card, the customer “reaffirms” or acknowledges the owed debt to the debt-holder. The debt-holder then issues the customer a credit card and transfers the balance of the preexisting debt to the credit card. By making payments on the owed debt, a line of credit available to the customer may increase. This is attractive to the customer, because the customer receives an incentive (a line of available credit on a credit card) for paying a pre-existing debt. This is also attractive to the debt-holder, because the debt-holder is receiving payments on an account that was charged off.

Conventional reaffirmation credit cards typically work as follows. A debt-holder will offer a reaffirmation credit card to a customer with pre-existing debt. If the customer accepts, the customer reaffirms the pre-existing debt in exchange for a potential line of credit on a reaffirmation credit card. Once the customer accepts the offer, the debt-holder may notify credit bureaus that the pre-existing debt is paid off. The reaffirmed debt is then reported to the credit bureaus as a new loan. The customer stays in good standing with the debt-holder by making payments on the new loan. If the customer fails to make regular payments, the debt-holder updates the customer's credit record accordingly.

In this system, although customers are given the incentive of a potential line of credit for making payments on a pre-existing debt, customers who fail to make a required payment receive additional derogatory marks on their credit reports. Upon reaffirmation, the debt-holder notifies credit bureaus that the original debt is paid off. Negative payment history of that original debt, however, remains with the customer's credit history for a predetermined time. And if the customer reaffirms the debt, but fails to make regular payments on the reaffirmed or balance-transfer debt, an additional derogatory mark appears on the customer's credit history.

The debt-holder may face a similar problem. If a customer defaults on a reaffirmed debt, the debt-holder may have to charge-off the reaffirmation new account. This is in addition to the charged-off debt already related to the original debt. Regardless of whether the reaffirmation account is offered by the original debt holder or the debt is purchased by a collection agency, who then offers the reaffirmation account, the new creditor desires to avoid charging-off an account. As discussed above, reported charge-offs are an important, negative industry metric. Debt holders thus want to reduce the number of accounts that they report as charged-off.

Finally, in the case where a debt-holder is selling a portfolio of charged-off accounts to a collection agency, the debt-holder is at a significant disadvantage, because the true value of the charged-off accounts is difficult to accurately predict. Since the buyer of the debt is thus taking a risk by buying these non-performing assets, the seller may be unable to get what it may consider a fair price based on the debt amount actually collected. The buyer and the seller may then agree to pay for each account based on whether a payment is received. If a required payment is received, the buyer may then pay more for that account since it is a more valuable account. However, the new debt-holder still runs the risk of charging-off the newly purchased account.

Accordingly, there is a need for improved systems and methods for offering a reaffirmation credit card or other balance transfer accounts to customers, such that the customer is given a chance to pay off the pre-existing debt without incurring an additional derogatory mark on their credit history. There is also a need for systems and methods that permit creditors to offer such a reaffirmation credit card without facing potential negative metrics in the form of additional charged-off accounts. Finally, there is a need for improved systems and methods such that the debt-holder of the pre-existing debt may increase the value of each account to be settled via reaffirmation or balance transfer.

### SUMMARY OF THE INVENTION

Systems and methods consistent with the present invention manage balance transfer accounts in a way that provides the customer with a greater incentive to pay off the debt, while limiting the possibility that the account will be charged-off.

Specifically, systems and methods consistent with the present invention manage a balance transfer account associated with a customer's pre-existing debt account. A balance transfer account is first created for the customer. It is then determined whether a payment to the balance transfer account received from the customer meets a payment threshold criteria. If the received payment meets the payment threshold criteria, then a credit bureau is notified of the balance transfer account. If the received payment does not meet the payment threshold criteria, then the created balance transfer account is closed without notification to the credit bureau.

Another aspect of the invention similarly relates to systems and methods that managing a balance transfer account associated with a pre-existing debt account of a customer, and that perform the following: opening a balance transfer account for the customer; determining whether a payment to the balance transfer account received from the customer meets a payment threshold criteria; if the received payment meets the payment threshold criteria, then keeping the balance transfer account open; and if the received payment does not meet the payment threshold criteria, then closing the balance transfer account.

A still further aspect of the invention similarly relates to systems and methods that manage a balance transfer account associated with a customer's pre-existing debt account, and that perform the following: creating a balance transfer account for the customer; determining whether a payment to the balance transfer account received from the customer meets a payment threshold criteria; if the received payment meets the payment threshold criteria, then opening the balance transfer account; and if the received payment does not meet the payment threshold criteria, then not opening the balance transfer account.

Both the foregoing general description and the following detailed description are exemplary and are intended to provide further explanation of the embodiments of the invention as claimed.

### BRIEF DESCRIPTION OF THE DRAWINGS

The accompanying drawings, which are incorporated in and constitute a part of this specification, illustrate various embodiments of the present invention, and, together with the description, serve to explain the principles of the invention. In the drawings:

FIG. 1 is an exemplary block diagram of a system for managing a reaffirmation credit card account consistent with the principles of the present

FIG. 2 is an exemplary flow chart of a method, consistent with the principles of the present invention, for managing a reaffirmation credit card account.

### DETAILED DESCRIPTION

Systems and methods consistent with the present invention provide an incentive to customers to pay-off or reaffirm their overdue outstanding debt. The present invention may thus improve debt recovery by debt-holders and decrease the negative metrics faced by those debt-holders from unrecoverable debt. The incentive to the customer to reaffirm the debt may include the ability to pay-off or reaffirm the debt without receiving an additional derogatory mark on their credit history if they fail to make required payments. Furthermore, while the present invention is described with respect to managing reaffirmation accounts, systems and methods consistent with the present invention may manage any type of balance transfer or credit account.

Systems and methods consistent with the present invention may create reaffirmation accounts for customers who have overdue outstanding debt associated with an original account. Even though the account may be offered and provided to a customer, the financial institution that issues the account will forgo reporting the account to a credit bureau until after the customer makes a required payment. After the required payment is received, the system may transfer ownership of the original debt to the newly created account, and report the new reaffirmation account to the credit bureau. If, on the other hand, the customer does not make the required payment to the new reaffirmation account, then the system closes the new account and the balance is returned to the original account. Debt collection practices will then proceed with respect to the original account. Further, the system may then pay the previous owner of the debt a fee based on whether a payment was received from the customer.

The present invention also allows financial institutions to efficiently engage in the debt collection process. For instance, when purchasing from another debt-holder a portfolio of accounts having outstanding debt, a financial institution may pay more for those accounts in which the customer does make a payment on the outstanding debt. Because the invention may not transfer debt ownership until after the customer makes a required payment, the financial institution may then accurately determine that the account is a recoverable asset before purchase. Accordingly, systems and methods consistent with the present invention will pay more for these accounts than those in which no payment is received. For those accounts in which the customer does not make a payment, the financial account may simply pay a lesser amount or nothing at all and return the original account to the original debt holder.

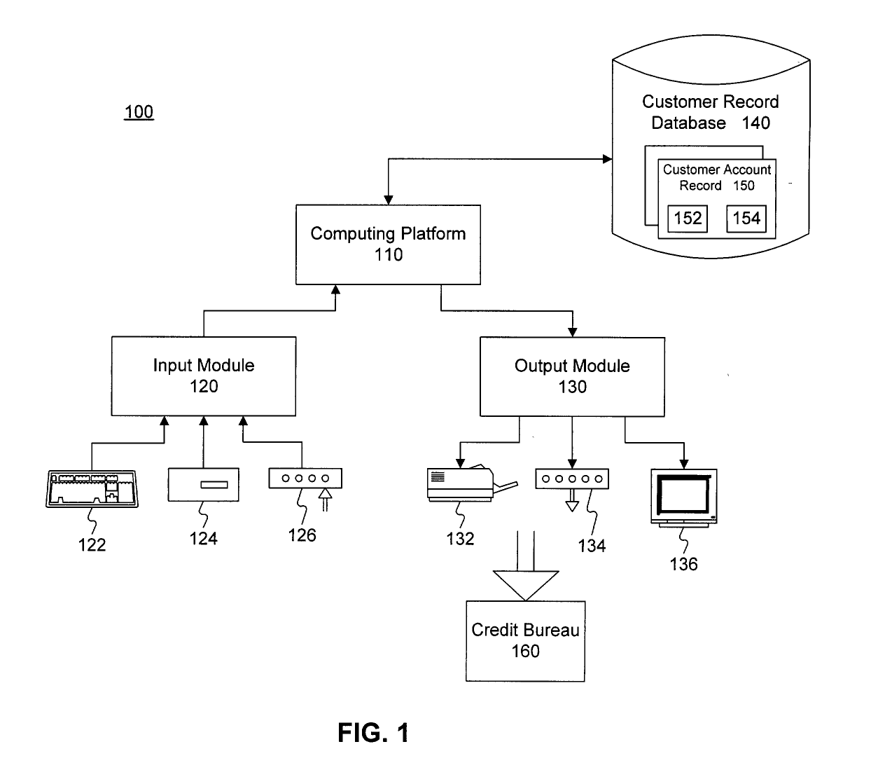

By way of a non-limiting example, FIG. 1 illustrates a system environment 100 for implementing the features and principles consistent with the present invention. As illustrated in FIG. 1, the system 100 includes a computing platform 110, an input module 120, an output module 130, and a customer record database 140. Customer record database 140 may further include customer account records 150. System 100 may also include a connection to a credit bureau 160.

Computing platform 110 may comprise any computer, such as a personal computer, workstation, or mainframe computer for performing various functions and operations of the invention. Computing platform 110 may be implemented, for example, by a general purpose computer selectively activated or reconfigured by a computer program stored in the computer, or may be a specially constructed computing platform for implementing the features and operations of the present invention. Computing platform 110 may also be implemented or provided with a wide variety of components or subsystems including, for example, one or more of the following: a central processing unit, a co-processor, memory, a data register, and other data storage and/or processing devices and subsystems.

Computing platform 110 may process outstanding debt and payment information received from input module 120. Computing platform 110 may also provide account information to output module 130. Additionally, computing platform 110 may access information in customer record database 140 to determine customer credit history information, which may then be provided to output module 130.

Input module 120 further includes an input device 122, a storage device 124, and/or a network interface 126. Input device 122 may include a keyboard, mouse, or other data entering device. Storage device 124 may include a disk drive, optical drive, CD-ROM, or other device for reading data stored on a medium. Network interface 126 may receive information over any type of network (not shown), such as a telephony-based network (e.g., PBX or POTS), a local area network, a wide area network, a dedicated intranet, and/or the Internet.

Input module 120 may be used to enter or obtain information about the customer, such as customer identification information, the customer's outstanding debt on the original account, and/or payments or charges made by the customer to that account. For example, when creating a new reaffirmation account, information entered or obtained by input module 120 may include customer identification information, such as the customer's name, address, phone number, or Social Security number. Input module 120 may also be used to obtain or enter information about the outstanding debt of the original account, such as the original debt holder, the debt amount, the length of the debt delinquency, as well as other debt collection information. Information received by module 120 may be transferred automatically from the original holder of the debt or may be entered manually by the issuer of the reaffirmation account.

After a new reaffirmation account has been created and the customer has been issued a reaffirmation credit card, input module 120 may be used to input or obtain transaction information associated with the reaffirmation credit card. This transaction information may include any payment amounts made by the customer to the reaffirmation account, the date of such payments, the amount charged by the customer to the reaffirmation account, and the provider of goods or services to whom any charges were made. Input module 120 may forward the received transaction information to computing platform 110 for processing and/or storage in customer record database 140.

Computing platform 110 may provide reaffirmation account information generated by computing platform 110 or obtained from customer record database 140 to output module 130. Output module 130 may output the reaffirmation account information to the customer, to personnel of the reaffirmation account issuer for use internally or for assisting the customer, or may output this information in an appropriate form to credit bureaus 160 for updating the customer's credit history. The reaffirmation account information may include the pre-existing debt balance, the amount of credit available, the minimum payment amount due, and the payment history on the account.

As shown in FIG. 1, output module 130 further includes a printer device 132, a network interface 134, and/or a display device 136. Printer device 132 may be used to provide a conventional printed record. Network interface 134 may provide this information to the customer, to the reaffirmation account issuer, or a to the credit bureaus 160, via any type of network as described above with respect to input module 120. Display device 136 may provide account information to a representative of the account issuer, either for assisting the customer or for forwarding to the credit bureaus 160.

Customer record database 140 stores customer account records 150. Each customer account record 150 may include a pre-existing debt record 152 and a payment history account record 154, as well as other identifying information concerning the customer and the reaffirmation account. Pre-existing debt account record 152 may store information concerning the outstanding debt of the customer, such as information about the pre-existing debt amount and the original holder of that debt. Payment history account record 154 may store information about payments made by the customer to the issuer of the new reaffirmation account. The payment information may include, for example, the amount of each payment made, the date the payment was made, and the date the payment was due.

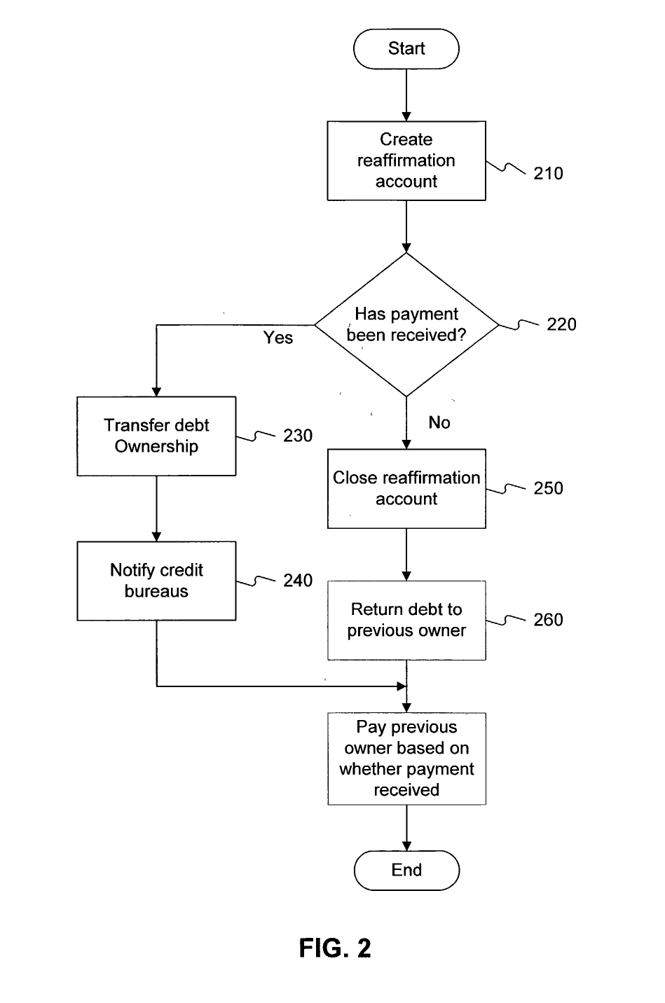

FIG. 2 illustrates an exemplary process, consistent with the present invention, for managing a reaffirmation financial account. As shown in FIG. 2, system 100 may create a new reaffirmation account for each customer having outstanding overdue debt associated with an original account (step 210). System 100 may receive information on an original account in a number of ways. For instance, a financial institution may purchase a portfolio of overdue debt accounts from a previous owner of the debt. The financial institution may offer reaffirmation accounts to each of the customers in the purchased portfolio or may identify particular customers from within the purchased portfolio of delinquent accounts to offer an account. In either case, the financial institution may buy the accounts at a fraction of the actual outstanding debt value, with the intention of collecting more than the amount paid for those accounts.

When identifying particular customers to target for a reaffirmation account, the financial institution may gather from credit bureau 160 necessary information about customers having overdue debt. From this information, the financial institution may determine whether those customers meet predetermined qualification criteria for a reaffirmation account by using credit risk models known in the art. For instance, targeted customers may be required to meet a predetermined credit profile based on, for example, the customer's payment history, income, or FICO credit score, as well as how many of the customer's previous accounts were charged-off or the length of time the original account was kept open. This criteria may indicate which customers are likely to accept the offer of a reaffirmation credit card. For example, the criteria may identify customers whose period of payment delinquency is within a predetermined time period, such as a delinquency of less than 180 days. The criteria may also indicate customers who have an outstanding overdue debt that falls within a range of acceptable debt.

To create the new account, input module 120 may receive information about the original account from the previous debt owner. This process may involve transferring customers' outstanding overdue debt to the reaffirmation account and providing those customers with reaffirmation credit cards. Thus the new account may include a line of credit for the customer in the amount of the pre-existing debit. The original account information may include information about the pre-existing debt, such as the debt amount, the original credit-issuer or debt holder, and/or the length of payment delinquency. After system 100 obtains this information, system 100 creates a customer account record 150 for each customer. Each record 150 may include a pre-existing debt account record 152 and a payment history record 154. The pre-existing debt account record 152 may store information about the pre-existing debt, while payment history record 154 may store information associated with payments to the new account.

System 100 may then offer the created reaffirmation accounts to the customers in a number of ways, such as via electronic e-mail, regular mail, telephone, or other forms of advertisement. When offered the account, the customer may receive a credit card associated with the new reaffirmation account. In systems consistent with the present invention, the credit card may be any type of credit account known in the art, such as standard physical credit cards, smart cards, or Internet credit cards. After receiving the credit card, the customer may contact system 100 to “open” the new account (e.g., activate the account for purchase transactions). However, system 100 may also send customers activated cards so that they do not need to activate the accounts themselves.

System 100 may then enter a period of billing cycles, similar to those of a conventional credit account. A billing cycle may occur monthly, as is conventional, but may also occur over any time period as determined by system 100. A statement may be sent to the customer at the end of each billing cycle and may include a conventional paper-based statement, mailed to the customer before the due date of the payment. Alternatively, the statement may be Internet-based, either available on a website or sent to the customer via e-mail. In any case, the statement may include information about the amount of payment due, the due date of the payment, and any other information that may assist the customer in using the account.

After providing the customer with a billing statement, the system awaits receipt of the payment from the customer (step 220). If system 100 receives a payment from the customer, computing platform 110 may determine whether the payment meets a payment threshold criteria. For example, the threshold criteria may require that a minimum payment be received within a predetermined time period, such as three months. In one alternative embodiment, the threshold criteria may require receipt of at least a certain payment amount, such as full payment of the original debt. In a further alternative, the threshold criteria may require receipt of a predetermined number of timely payments. In still other alternatives, the payment threshold criteria may include a requirement that the customer agree to secure payments by a lien on assets, allow automatic monthly withdrawal from a bank account for payments, allow for payments by payroll deduction, or have a guarantor for guaranteeing payments. Computing platform 110 may access payment history record 154 to determine if the customer has met the above threshold criteria.

If the payment threshold criteria is met, system 100 may then transfer the ownership of the pre-existing debt to the issuer of the reaffirmation account and close the pre-existing debt of the original account (step 230). As part of the processing of step 230, system 100 may permanently retain the customer's outstanding debt previously transferred to the new account.

In the above exemplary embodiment of the invention, system 100 “opens” the new account (e.g., activates the created account sent to the customer) as part of step 210. In an alternative embodiment of the invention, however, system 100 may wait to actually open the new account until after the customer makes a payment. By not opening the reaffirmation account until after the customer makes the required payment of step 220, the new account issuer may also prevent incurrence of a charge-off for a newly opened account that ends up being a non-performing account.

Returning to the exemplary embodiment of FIG. 2, system 100 may then notify a credit bureau 160 of the new credit account (step 240). For instance, the credit bureaus may be notified that the customer's pre-existing debt account has been paid, that the original account has been closed, and that the customer has been extended a new loan in the amount of the pre-existing debt. System 100 may also forward other information about the customer and/or account to the credit bureaus. Further, after closing the debit of the original account, system 100 manages the new account according to standard financial account management procedures well known to those skilled in the art.

If the payment threshold criteria is not met, however, system 100 closes the reaffirmation account created for the customer (step 250). In this case, the debt ownership has not yet been transferred and the original account remains open. Further, because system 100 has closed the account and not taken ownership of the pre-existing debt, system 100 does not notify the credit bureaus of the reaffirmation account. In this way, system 100 prevents an additional derogatory entry on the customer's credit history for failing to make payment to the new reaffirmation account. Finally, system 100 may then return the pre-existing debt to its original owner or similarly notify the original owner that system 100 will not be transferring ownership of that debt to the issuer of the reaffirmation account (step 260).

In systems consistent with the present invention, the issuer of the new account may pay a commission to the original debt-holder for each account after it is opened as part of step 230 (step 270). When a payment is received at step 220, the new account issuer may consider the account as a performing asset. Accordingly, the account issuer may be willing to pay a greater commission as compared to the conventional practice of paying a set amount for each account within a purchased portfolio. If system 100 closes the reaffirmation account as part of step 250, then the account issuer may return the original account to the original creditor and not pay any commission or a lesser amount than when a payment is received.

Therefore, as described above, systems and methods consistent with the present invention offer balance transfer accounts to customers that provide an incentive to pay off the pre-existing debt without incurring an additional derogatory mark on their credit history if they fail to meet required payment criteria. At the same time, the present invention reduces the potential that a financial institution will need to charge-off a balance transfer account.

Further, as noted above, systems and methods consistent with the present invention may manage any type of balance transfer account, not simply those associated with reaffirmation accounts or for original accounts that have been charged-off. For instance, system 100 may be used to manage balance transfer accounts that are delinquent, but not yet charged-off by the financial institution. System 100 may also be used to manage new accounts opened by a customer who then transfers an existing, not delinquent, balance from a previous account. System 100 may also be used to manage various types of installment loans. In each of these embodiments, system 100 may require receipt of a payment before opening the account.

Systems and methods consistent with the present invention may also determine whether, in step 220, the customer meets predetermine qualification criteria not necessarily based on payments made to the balance transfer account. For example, the created reaffirmation account may be kept open for the customer if the customer meets other criteria, besides making required payments, such as responding to an address verification request, acknowledging the debt owed, making attempts to clear the customer's credit, or agreeing to have the new account reported to a credit bureau.

The above-noted features and other aspects and principles of the present invention may be implemented in various systems or network environments to provide automated computational tools for managing account records and performing tests to determine if various criteria are met. Such environments and applications may be specifically constructed for performing various processes and operations of the invention or they may include a general purpose computer or computing platform selectively activated or reconfigured by program code to provide the necessary functionality. The processes disclosed herein are not inherently related to any particular computer or apparatus, and may be implemented by a suitable combination of hardware, software, and/or firmware. For example, various general purpose machines may be used with programs written in accordance with the teachings of the invention, or it may be more convenient to construct a specialized apparatus or system to perform the required methods and techniques. The present invention also relates to computer readable media that include program instruction or program code for performing various computer-implemented operations based on the methods and processes of the invention. The media and program instructions may be those specially designed and constructed for the purposes of the invention, or they may be of the kind well-known and available to those having skill in the computer software arts. Examples of program instructions include both machine code, such as produced by a compiler, and files containing a high level code that can be executed by the computer using an interpreter.

It will be apparent to those skilled in the art that various modifications and variations can be made to the invention without departing from the scope or spirit of the invention. For example, criteria other than the payment threshold may be used to determine whether to open the reaffirmation account. Other modifications and embodiments of the invention will be apparent to those skilled in the art from consideration of the specification and practice of the invention disclosed herein. Therefore, it is intended that the specification and examples be considered as exemplary only, with a true scope and spirit of the invention being indicated by the following claims.

What is claimed is:

1. A method for managing a balance transfer account associated with a pre-existing debt account of a customer, the method comprising:
creating a balance transfer account for the customer;
determining whether a payment to the balance transfer account received from the customer meets a payment threshold criteria;
if the received payment meets the payment threshold criteria, then notifying a credit bureau of the balance transfer account; and
if the received payment does not meet the payment threshold criteria, then closing the created balance transfer account without notification to the credit bureau.

2. The method of claim 1, wherein creating the balance transfer account further comprises:
transferring the pre-existing debt of the customer to the balance transfer account.

3. The method of claim 1, wherein creating the balance transfer account further comprises:
creating the balance transfer account to have a line of credit based on the amount of the pre-existing debt.

4. The method of claim 1, wherein creating the balance transfer account further comprises:
opening the balance transfer account.

5. The method of claim 4, wherein if the received payment meets the payment threshold criteria, the balance transfer account remains open.

6. The method of claim 1, wherein if the received payment meets the payment threshold criteria, the method further comprising:
closing the pre-existing debt account.

7. The method of claim 6, further comprising:
notifying a credit bureau of the closure of the pre-existing debt account.

8. The method of claim 1, wherein the payment threshold criteria is based on at least one of the following: number of payments received from the customer to the balance transfer account; amount of payments received; and timeliness of payments received, agreeing to secure payments, agreeing to allow automatic monthly withdrawal from a financial or payroll account for payments, and agreeing to have a guarantor for guaranteeing payments.

9. The method of claim 1, further comprising:
paying a commission to the original debt-holder of the pre-existing debt based on receipt of a payment to the balance transfer account.

10. The method of claim 1, wherein the balance transfer account is a reaffirmation account.

11. A system for providing a balance transfer account associated with a pre-existing debt account of a customer, the system comprising:
means for creating a balance transfer account for the customer;
means for determining whether a payment to the balance transfer account received from the customer meets a payment threshold criteria;
means for notifying a credit bureau of the balance transfer account if the received payment meets the payment threshold criteria; and
means for closing the created balance transfer account without notification to the credit bureau if the received payment does not meet the payment threshold criteria.

12. The system of claim 11, wherein the means for creating the balance transfer account further comprises:
means for transferring the pre-existing debt of the customer to the balance transfer account.

13. The system of claim 11, wherein the means for creating the balance transfer account further comprises:
means for creating the balance transfer account to have a line of credit based on the amount of the pre-existing debt.

14. The system of claim 11, wherein the means for creating the balance transfer account further comprises:
means for opening the balance transfer account.

15. The method of claim 14, wherein if the received payment meets the payment threshold criteria, means for keeping the balance transfer account open.

16. The system of claim 11, wherein if the received payment meets the payment threshold criteria, the system further comprising:
means for closing the pre-existing debt account.

17. The system of claim 16, further comprising:
means for notifying a credit bureau of the closure of the pre-existing debt account.

18. The system of claim 11, wherein the payment threshold criteria is based on at least one of the following: number of payments received from the customer to the balance transfer account; amount of payments received; and timeliness of payments received, agreeing to secure payments, agreeing to allow automatic monthly withdrawal from a financial or payroll account for payments, and agreeing to have a guarantor for guaranteeing payments.

19. The system of claim 11, further comprising:
means for paying a commission to the original debt-holder of the pre-existing debt based on receipt of a payment to the balance transfer account.

20. The system of claim 11, wherein the balance transfer account is a reaffirmation account.

21. A method for managing a balance transfer account associated with a pre-existing debt account of a customer, the method comprising:
opening a balance transfer account for the customer;
determining whether a payment to the balance transfer account received from the customer meets a payment threshold criteria;
if the received payment meets the payment threshold criteria, then keeping the balance transfer account open; and
if the received payment does not meet the payment threshold criteria, then closing the balance transfer account.

22. A method for managing a balance transfer account associated with a pre-existing debt account of a customer, the method comprising:
creating a balance transfer account for the customer;
determining whether a payment to the balance transfer account received from the customer meets a payment threshold criteria;
if the received payment meets the payment threshold criteria, then opening the balance transfer account; and
if the received payment does not meet the payment threshold criteria, then not opening the balance transfer account.

23. The method of claim 22, wherein the step of opening the balance transfer account further includes:
activating the balance transfer account and transferring the pre-existing debt of the customer to the balance transfer account; and
wherein the method further includes closing the pre-existing debt account.

24. The method of claim 22, wherein the step of opening the balance transfer account further includes:
notifying a credit bureau of the opening of the balance transfer account.

25. The method of claim 22, further including:
notifying a credit bureau of the closure of the pre-existing debt account when the pre-existing debt account is closed.

26. The method of claim 22, wherein the payment threshold criteria is based on at least one of the following: number of payments received from the customer to the balance transfer account; amount of payments received; and timeliness of payments received, agreeing to secure payments, agreeing to allow automatic monthly withdrawal from a financial or payroll account for payments, and agreeing to have a guarantor for guaranteeing payments.

27. The method of claim 22, wherein the step of opening the balance transfer account further includes:
closing the pre-existing debt account; and
opening the balance transfer account to have a line of credit based on the amount of the pre-existing debt.

28. The method of claim 22, further including:
paying a commission to the original debt-holder of the pre-existing debt based on the opening of the balance transfer account.

29. The method of claim 22, wherein the balance transfer account is a reaffirmation account.

30. A method for managing a balance transfer account associated with a pre-existing debt account of a customer, the method comprising:
creating a balance transfer account for the customer;
determining whether the customer satisfies predetermined qualification criteria;
if the customer satisfies predetermined qualification criteria, then notifying a credit bureau of the balance transfer account; and
if the customer satisfies predetermined qualification criteria, then closing the created balance transfer account without notification to the credit bureau.
